(19) United States
(12) Patent Application Publication
(10) Pub. No.: US 2021/0368253 A1
(43) Pub. Date: Nov. 25, 2021

(54) NECK-STRAP TYPE EARPHONE

(71) Applicant: SHENZHEN XIAN YUAN TECHNOLOGY CO., LTD, Shenzhen (CN)

(72) Inventor: Lin ZOU, Shenzhen (CN)

(73) Assignee: SHENZHEN XIAN YUAN TECHNOLOGY CO., LTD, Shenzhen (CN)

(21) Appl. No.: 16/620,173

(22) PCT Filed: Dec. 18, 2018
(86) PCT No.: PCT/CN2018/121783

§ 371 Date: Dec. 6, 2019

(30) Foreign Application Priority Data
Nov. 13, 2018 (CN) 201811344824.5

(51) Int. Cl. H04R 1/10

(52) U.S. Cl. CPC H04R 1/105; H04R 1/1025; H04R 2420/07; H04R 1/1033; H04R 1/1016

(57) ABSTRACT

A neck-strap type earphone includes a wireless earphone assembly and a neck strap. The neck strap is provided with two neck strap connectors and a battery unit, and the two neck strap connectors are arranged on the neck strap and are connected to the battery unit. The wireless earphone assembly includes a left earphone and a right earphone that can be worn and used separately, each of the left earphone and the right earphone is provided with an earphone connector, and the earphone connectors are detachably connected to the neck strap connectors. The left earphone and the right earphone are connected through the neck strap, which are convenient to use and receive. The battery unit can supply power to and charge the wireless earphone assembly, and a user can continually wear the wireless earphone assembly, thereby improving the user's use experience.

### CROSS-REFERENCES TO RELATED APPLICATIONS

The present application is a national phase of a PCT Application No. PCT/CN2018/121783 (filed on Dec. 18, 2018), and claims priority to Chinese Patent Application No. 201811344824.5 (filed on Nov. 13, 2018), entitled “a neck-strap type earphone,” the contents of which are incorporated herein by reference thereto.

### TECHNICAL FIELD

The present application relates to the field of earphone technologies, and more specifically to a neck-strap type earphone.

### BACKGROUND

A Bluetooth earphone is wireless earphone acquired through applying a Bluetooth technology to the field of earphones, which is connected with an audio device (such as a mobile phone) without a requirement of an earphone cord during use, so that a user can avoid the tie of the earphone cord during use, thereby making the use process more flexible and convenient. With the development and maturity of the technology, a TWS (true wireless stereo) Bluetooth earphone has begun to appear in people's view, and a Bluetooth chip and a battery are arranged in the earphone, which is not only connected with the audio device without a requirement of an earphone cord, but also the two headphones are connected without a requirement of an earphone cord, therefore it has a smaller overall volume, is suitable to be worn when doing exercise, and is more convenient to be used.

However, there are only two earphones existed independently in the existing TWS Bluetooth earphones, which are easy to be lost when the user performs strenuous exercise. Moreover, the power consumption of the earphones is large, the battery life after a single charge is limited, and the earphones need to be taken off and placed into a charging box during charging, and then is worn and used after being fully charged. The earphones have cumbersome operations, and cannot be used continuously, resulting in poor user experience.

### TECHNICAL PROBLEM

Embodiments of the present application are aimed to provide a neck-strap type earphone, which solves technical problems existed in the prior art including, but not limited to, that the TWS Bluetooth earphones cannot be worn when charging.

### SUMMARY

In order to solve the above technical problems, embodiments of the present application adopts a technical solution, i.e., a neck-strap type earphone is proposed, which includes a wireless earphone assembly and a neck strap.

The neck strap is provided with two neck strap connectors and a battery unit, and the two neck strap connectors are arranged on the neck strap and connected with the battery unit;

the wireless earphone assembly includes a left earphone and a right earphone that are capable of being worn and used separately;

the left earphone and the right earphone are provided with an earphone connector, and the earphone connectors are detachably connected with the neck strap connectors;

the left earphone and the right earphone are able to be worn and used when connected with the neck strap.

### BENEFICIAL EFFECTS

The beneficial effects of the neck-strap type earphone provided by the embodiments of the present application lie in the following.

(1) It is not required to connect the left earphone with the right earphone in the wireless earphone assembly through an earphone cord, and the two exist independently of each other and can also be used independently. The left earphone and the right earphone may further be connected with the neck strap, and the connection with the neck strap will not affect the wearing of the wireless earphone assembly, and the neck strap achieves good protection for the left earphone and the right earphone at the same time, thereby preventing them from being lost due to strenuous exercise.

(2) Through providing the battery unit in the neck strap, when the power of the left earphone and the right earphone is insufficient, the battery unit can supply power to them and can also charge them at the same time, which avoids that the user cannot use the earphones due to insufficient power when the earphones are in urgent need of use, thereby greatly expanding their usage scenarios and improving user's use experience.

### DESCRIPTION OF THE DRAWINGS

In order to more clearly illustrate the technical solutions in the embodiments of the present application, the drawings used in the description of the embodiments or the prior art will be briefly described below. It is obvious that, the drawings in the following description are only some embodiments of the present application, and other drawings may be obtained based on these drawings for those of ordinary skill in the art without paying creative effort.

FIG. 1 is a schematic view showing a first structure of the neck-strap type earphone according to an embodiment of the present application.

FIG. 2 is a schematic view showing a first exploded structure of the neck-strap type earphone according to an embodiment of the present application.

FIG. 3 is a first schematic view showing a structure of a neck strap in a first structure of the neck-strap type earphone according to an embodiment of the present application.

FIG. 4 is a second schematic view showing a structure of a neck strap in the first structure of the neck-strap type earphone according to an embodiment of the present application.

FIG. 5 is a first schematic view showing an exploded structure of a right earphone in the first structure of the neck-strap type earphone according to an embodiment of the present application.

FIG. 6 is a second schematic view showing an exploded structure of a right earphone in the first structure of the neck-strap type earphone according to an embodiment of the present application.

FIG. 7 is a schematic view showing a partial cross-section structure of the first structure of the neck-strap type earphone according to an embodiment of the present application.

FIG. 8 is a schematic view showing a second structure of the neck-strap type earphone according to an embodiment of the present application.

FIG. 9 is a schematic view showing a second exploded structure of the neck-strap type earphone according to an embodiment of the present application.

FIG. 10 is a schematic view showing a structure of the neck strap in the second structure of the neck-strap type earphone according to an embodiment of the present application.

FIG. 11 is a schematic view showing an exploded structure of the right earphone in the second structure of the neck-strap type earphone according to an embodiment of the present application.

FIG. 12 is a schematic view showing a partial cross-section structure of the second structure of the neck-strap type earphone according to an embodiment of the present application.

FIG. 13 is a schematic view showing a third structure of the neck-strap type earphone according to an embodiment of the present application.

FIG. 14 is a schematic view showing a third exploded structure of the neck-strap type earphone according to an embodiment of the present application.

FIG. 15 is a schematic view showing a structure of the neck strap in the third structure of the neck-strap type earphone according to an embodiment of the present application.

FIG. 16 is a schematic view showing an exploded structure of the right earphone in the third structure of the neck-strap type earphone according to an embodiment of the present application.

FIG. 17 is a schematic view showing a partial cross-section structure of the third structure of the neck-strap type earphone according to an embodiment of the present application.

FIG. 18 is a schematic view showing a fourth structure of the neck-strap type earphone according to an embodiment of the present application.

FIG. 19 is a schematic view showing a fourth exploded structure of the neck-strap type earphone according to an embodiment of the present application.

FIG. 20 is a schematic view showing a structure of the neck strap in the fourth structure of the neck-strap type earphone according to an embodiment of the present application.

FIG. 21 is a schematic view showing an exploded structure of the right earphone in the fourth structure of the neck-strap type earphone according to an embodiment of the present application.

FIG. 22 is a schematic view showing a partial cross-section structure of the fourth structure of the neck-strap type earphone according to an embodiment of the present application.

### EMBODIMENTS OF THE PRESENT APPLICATION

In order to make the technical problems to be solved, the technical solutions and the beneficial effects of the present application more clear and comprehensible, the present application will be further described in detail below with reference to the accompanying drawings and embodiments. It should be understood that, the specific embodiments described herein are merely to illustrate the present application and are not intended to limit the present application.

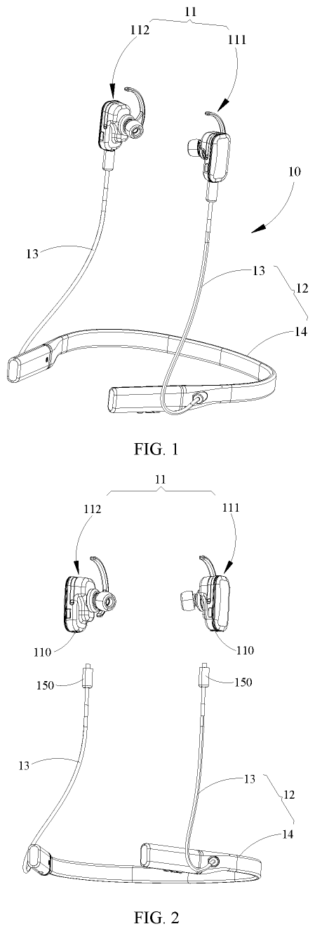

Referring to FIG. 1 and FIG. 2, the neck-strap type earphone 10 includes a wireless earphone assembly 11, and a neck strap 12 configured to wear at a neck of a user. The neck strap 12 is provided with two neck strap connectors 150 and a battery unit 151, and the two neck strap connectors 150 are disposed on the neck strap 12 and are both connected to the battery unit 151. The wireless earphone assembly 11 includes a left earphone 111 and a right earphone 112 that can be worn separately, each of the left earphone 111 and the right earphone 112 is provided with an earphone connector 110, and the earphone connector 110 is detachably connected to the neck strap connector 150. The left earphone 111, the right earphone 112 and the neck strap 12are wearable and usable when they are connected.

The left earphone 111 and the right earphone 112 are both true wireless earphones (for example, TWS Bluetooth earphones), that is to say, the wireless earphone assembly 11 and an audio device are connected without an earphone cord, and it is not required to connect the left earphone 111 with the right earphone 112 through an earphone cord. When using the neck-strap type earphone 10, the user may wear the left earphone 111 only, or may wear the right earphone 112 only, or may wear the left earphone 111 and the right earphone 112 at the same time, or may further wear the left earphones 111 and the right earphones 112 in a case that the neck strap 12 is connected with the left earphone 111 and the right earphone 112, which can be set as needed and no limitation is made here.

The neck strap 12 may connect the left earphone 111 with the right earphone 112, and the neck strap 12 can be worn at the neck of the user. When the user needs to take off the left earphone 111 and the right earphone 112 during use, the neck strap 12 can play a role of receiving, such that the user only needs to take off the left earphone 111 and the right earphone 112 from auricles and make them hang down naturally. When the left earphone 111 and the right earphone 112 need to be used, the user only needs to wear them correspondingly, therefore the operation is simple and convenient. The battery unit 151 in the neck strap 12 may further charge and power the left earphone 111 and the right earphone 112. When the power of the left earphone 111 and the right earphone 112 is consumed and exhausted, the neck strap connectors 150 of the neck strap 12 are accordingly connected to the earphone connectors 110, and then the battery unit 151 can supply power to the left earphone 111 and the right earphone 112, meanwhile the user can continue to wear the left earphone 111 and the right earphone 112 without affecting its use. Of course, the left earphone 111 and the right earphone 112 can also be charged by other means, and are not limited to the above-described charging through the battery unit 151 in the neck strap 12, which is not limited herein.

The beneficial effects of the neck-strap type earphone 10 provided by this embodiment lie in at least the following.

(1) The two earphones exist separately among the existing TWS Bluetooth earphones. On one hand, they are easy to be lost when the user performs strenuous exercise, due to that the TWS Bluetooth earphone is small in size and light in weight. On the other hand, the user needs to store the earphones temporarily when feeling fatigue during using the earphones, and then continue to use them after mitigation, at this time, the user can only put the TWS Bluetooth earphones into a storage box, and then take out the earphones from the storage box when needed, the operation process is very cumbersome and the use experience is not good.

The present application completely solves the above-mentioned problem during use. On one hand, it is not required to connect the left earphone 111 with the right earphone 112 in the wireless earphone assembly 11 through an earphone cord, and the two exist independently of each other and can also be used independently. It has a small size and is convenient to be used, and the user can take and use it according to the need. When performing strenuous exercise, the user only needs to connect the left earphone 111 and the right earphone 112 to the neck strap 12, and the neck strap 12 may be placed at the neck of the user, in this case the connection with the neck strap 12 will not affect the wearing of the wireless earphone assembly 11, and the neck strap 12 achieves good protection for the left earphone 111 and the right earphone 112 at the same time, thereby preventing them from being lost due to strenuous exercise. On the other hand, when the user needs to temporarily take off the wireless earphone assembly 11 after wearing it for a long time, the user only needs to take off the left earphone 111 and the right earphone 112 and make them naturally hang down due to the existence of the neck strap 12. When needed to be used again, the left earphone 111 and the right earphone 112 may be worn directly and accordingly, thus the operation is simple and convenient, the user experience is greatly improved, and it is advantageous for the user to use them much frequently.

(2) When the existing TWS Bluetooth earphones are charging, the earphones need to be taken off and put into the charging box, and then are worn and used after being fully charged. Not only the operation is cumbersome, but the earphones cannot be used during the charging process, thereby resulting in a dilemma that the earphones cannot be used when the user urgently needs to use the earphones, and resulting in poor user experience.

The present application can effectively ensure that the user can use the earphones at any time if needing to use them. Through providing the battery unit 151 in the neck strap 12, when the power of the left earphone 111 and the right earphone 112 is insufficient, the battery unit 151 can supply power to the left earphone 111 and the right earphone 112and can also charge the left earphone 111 and the right earphone 112 at the same time, and the user can continue to wear the wireless earphone assembly 11 at this time, which effectively extends the duration of use, and avoids that the user cannot use the earphones due to insufficient power when the earphones are in urgent need of use, thereby greatly expanding their usage scenarios and improving user's use experience.

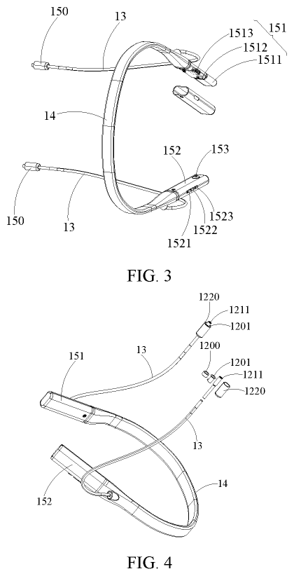

Referring to FIG. 2 and FIG. 3, in one embodiment, the neck strap 12 includes two connecting wires 13 and a collar 14. The two connecting wires 13 are connected with the collar 14, each of free ends of the two connecting wires 13 is connected with a neck strap connector 150, the battery unit 151 is provided in the collar 14, and the neck strap connector 150 is connected to the battery unit 151 through a wire provided in the connecting wire 13. During use, the left earphone 111 and the right earphone 112 are worn in the user's ears, the two connecting wires 13 are naturally hung down, and the collar 14 is placed on the neck of the user, thereby ensuring natural and comfortable wearing for the user. The material of the collar 14 may be selected as needed.

Referring to FIG. 1 and FIG. 8, in one embodiment, the collar 14 is made of a hard material, and its shape is adaptive to the shape of the neck of the user and is fixed. When the user wears, a middle portion of the collar 14 is placed at the user's back neck, and each of the two ends of the collar 14 extends forward around the neck to a corresponding position under the user's ear, which can ensure comfortable wearing for the user on the one hand, and can effectively prevent it from falling down during use on the other hand.

Referring to FIG. 13 and FIG. 18, in one embodiment, the collar 14 is made of a soft material, and its shape may be adjusted according to different users, thereby ensuring that the collar 14 may be adjusted to a most comfortable state when the user wears, and improving the user's use experience. It should be understood that in other embodiments, the collar 14 may also be made of other materials, for example, a portion is made of a hard material and a portion is made of a soft material, which is not limited herein.

Referring to FIG. 3, the battery unit 151 further includes a battery 1511 and a battery circuit board 1512. The battery 1511 is connected to the battery circuit board 1512, and the battery circuit board 1512 is connected to the neck strap connectors 150. A battery management chip is arranged on the battery circuit board 1512, so that the battery 1511 may be controlled to charge the wireless earphone assembly 11. For example, when the battery management chip detects that the battery of the wireless earphone assembly 11 is not fully charged, then the battery 1511 is controlled to charge the wireless earphone assembly 11, and when the battery management chip detects that the battery of the wireless earphone assembly 11 is fully charged, then the battery 1511 is disconnected from the wireless earphone assembly 11 so that charging is no longer performed. At the same time, the battery management chip may also detect whether the battery 1511 itself has sufficient power and control whether the battery 1511 needs to be charged. The number of the battery 1511 in the battery unit 151 may be arranged as needed, for example, it may be one, and at this time the two neck strap connectors 150 are connected to the battery 1511 through the battery circuit board 1512, and the battery unit 151 may be provided in one end portion of the collar 14. There may be two batteries 1511, and the two batteries 1511 are respectively provided at two end portions of the collar 14 to charge the left earphone 111 and the right earphone 112, respectively. Of course, the number of the batteries 1511 may also be more than two, which is not limited to the above cases.

In one embodiment, the battery 1511 is a rechargeable battery, preferably a lithium-ion rechargeable battery. In this case, the rechargeable battery may be fixed in the collar 14, the battery circuit board 1512 is provided with a charging connection portion 1513, and the charging connection portion 1513 may be a Micro USB interface, such that the rechargeable battery may be charged via an external power source. Of course, the charging connection portion 1513 may also be other types of power interfaces, which is not limited herein.

In one embodiment, the battery 1511 is a replaceable battery, such as a dry battery. In this case, the battery unit 151 further includes a battery box arranged in the collar 14, the battery 1511 is arranged in the battery box, and a cover of the battery box may be opened and closed to facilitate replacing it by the user.

Referring to FIG. 3, further, in order to better control the wireless earphone assembly 11, the neck strap 12 is further provided with a control unit 152. The control unit 152 is connected to the battery unit 151, and the control unit 152 is connected to the neck strap connection portions 150, so as to establish connection with the wireless earphone assembly 11 via the neck strap connection portions 150. The position of the control unit 152 provided on the neck strap 12 may be arranged as needed.

Referring to FIG. 3 and FIG. 13, in one embodiment, the control unit 152 is arranged on the collar 14 and may be located at a position near the battery unit 151 to facilitate connection with the battery circuit board 1512 of the battery unit 151. Or the control unit 152 may be located at a different end portion of the collar 14 opposite to the battery unit 151, thereby making the overall structure more harmonious and aesthetically pleasing.

Referring to FIG. 8 and FIG. 18, in one embodiment, the control unit 152 is arranged on the connecting wire 13, and may be located on any one of the connecting wires 13, so that the user can operate during use to implement control of the wireless earphone assembly 11.

Referring to FIG. 3, FIG. 10, FIG. 15, and FIG. 20, in one embodiment, the control unit 152 may be provided with one or more of a volume control button (including a volume up button 1521 and a volume down button 1522), a mode button 1523, and a control button 1524. The volume control button is configured to control volume of the left earphone 111 and the right earphone 112. The mode button 1523 may be configured to control an earphone mode of the wireless earphone assembly 11, such as a normal mode, a noise reduction mode, a loop mode, etc., such that diversified usage requirements from the user may be met, and the mode button 1523 may be long pressed to further implement power-on control and power-off control of the wireless earphone assembly 11. The control button 1524 may be configured to control a working state of the wireless earphone assembly 11, for example, pressing once means play/pause, pressing twice means switching to a next song, and pressing three times means switching to a previous song, and the like. Of course, the specific functions of the mode button 1523 and the control button 1524 may be set as needed, which are not limited to the above cases.

Referring to FIG. 3, in one embodiment, the neck strap 12 is further provided with a voice pickup 153 configured to acquire external voice (for example, the user may speak to the voice pickup 153) and convert the sound into an electrical signal for transmission to the wireless earphone assembly 11. The wireless earphone assembly 11 then processes the electrical signal and transmits it so that the other party of the conversation can hear the user's voice. Preferably, the voice pickup 153 is connected to the control unit 152, so that the overall integration can be improved. When the control unit 152 is arranged on the collar 14, the voice pickup 153 is also arranged on the collar 14 accordingly. When the control unit 152 is arranged on the connecting wire 13, the voice pickup 153 is also arranged on the connecting wire 13 accordingly.

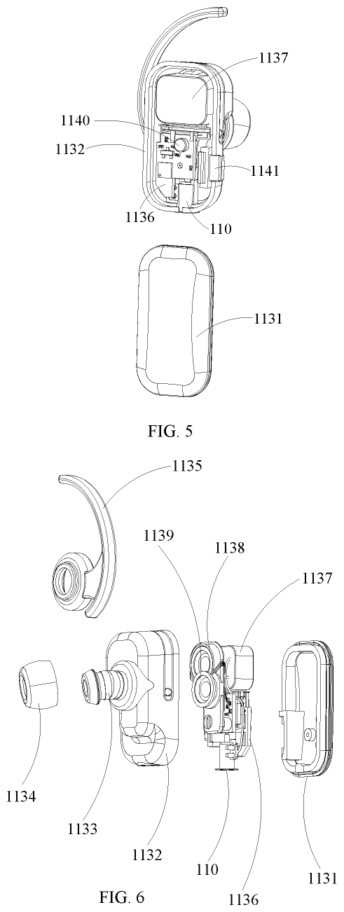

Referring to FIG. 5 and FIG. 6, further, the left earphone 111 and the right earphone 112 respectively include a rear housing 1131 and a front housing 1132 connected with the rear housing 1131. The front housing 1132 is provided with a bell mouth 1133 for inserting into an ear hole, the bell mouth 1133 is sleeved with an earplug 1134 made of a flexible material, and the earplug 1134 may be removed from the bell mouth 1133, such that the user can wear or remove it as needed during use, which facilitates use. The bell mouth 1133 is also sleeved with an integrated ear-hook 1135, and the integrated ear-hook 1135 may also be removed from the bell mouth 1133. When the user wears, the integrated ear-hook 1135 may be sleeved on the user's ear, therefore the wearing is more stable. The front housing 1132 is further provided with an earphone circuit board 1136, an earphone battery 1137, a moving-iron acoustic wave generator 1138, and a moving-coil acoustic wave generator 1139. The earphone battery 1137, the moving-iron acoustic wave generator 1138, and the moving-coil acoustic wave generator 1139 are connected with the earphone circuit board 1136, the earphone battery 1137 is arranged at one side of the earphone circuit board 1136 in the front housing 1132, and the moving-coil acoustic generator 1139 is arranged at a position near the bell mouth 1133 in the front housing 1132, such that the user can hear the voice from the left earphone 111 and the right earphone 112.

The earphone circuit board 1136 is provided with a main control chip capable of controlling other components. The earphone circuit board 1136 is further provided with an audio decoding chip and a filtering and noise reducing circuit, etc., so that the wireless earphone assembly 11 can not only work normally, but also can realize the function of noise reduction, which helps to improve the sound quality of the earphones. In order to connect with an audio device in a wireless manner, the earphone circuit board 1136 is further provided with a wireless communication module, and the wireless communication module is preferably a Bluetooth chip, meanwhile the earphone circuit board 1136 is further provided with a Bluetooth antenna, thereby ensuring the effect of transmitting and receiving a Bluetooth signal. Of course, the wireless communication module may also be an infrared communication module or a 2.4G communication module or other module as long as it can implement wireless communication with the audio device.

Referring to FIG. 5, in one embodiment, a control mode of the left earphone 111 or the right earphone 112 may be implemented by clicking, in this case the earphone circuit board 1136 is further provided with a clicking sensor 1140, so that the control of the earphones can be achieved according to different clicking frequencies of the user. For example, the volume can be decreased by double clicking on the left earphone 111, and the volume can be increased by double clicking on the right earphone 112. Of course, in other embodiments, clicking earphones can also realize other functions, which are not limited herein.

Referring to FIG. 5, in one embodiment, the earphone circuit board 1136 is further provided with an earphone control button 1141. The earphone control button 1141 extends to the outside of the front housing 1132 and the rear housing 1131 for convenient operation by the user, and may control the working modes of the wireless earphone assembly 11 according to different button-pressing manners. For example, with regard to the left earphone 111, pressing the earphone control button 1141 once corresponds to turning on/turning off ambient sound mode, pressing the earphone control button 1141 twice corresponds to turning on/turning off fast sound set, pressing the earphone control button 1141 three times corresponds to switching earphone mode/player mode, long pressing the earphone control button 1141 for two seconds corresponds to turning on/turning off Bluetooth, and long pressing the earphone control button 1141 for seven seconds corresponds to pairing Bluetooth. With regard to the right earphone 111, pressing the earphone control button 1141 once corresponds to play/pause, or answering the phone/ending the call, pressing the earphone control button 1141 twice corresponds to switching to the next song, pressing the earphone control button 1141 three times corresponds to switching to the previous song, and long pressing the earphone control button 1141 for two seconds corresponds to a voice assistant. Of course, in other embodiments, more button modes may be set, which are not limited to the above cases.

Regarding the interconnection of the earphone connectors 110 and the neck strap connectors 150, several alternative ways are provided below. It should be understood that, the connection form between the earphone connectors 110 and the neck strap connectors 150 may be set according to actual needs, which is not limited to the form described below.

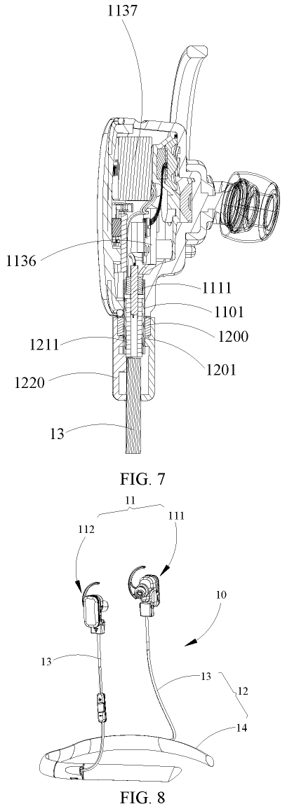

Referring to FIG. 4 and FIG. 7, in one embodiment, the earphone connectors 110 and the neck strap connectors 150 are connected by magnetic attraction. The earphone connectors 110 are provided with a first magnetic contact member 1101, and the neck strap connectors 150 are provided with a second magnetic contact member 1201, and the first magnetic contact member 1101 and the second magnetic contact member 1201 are cooperatively connected. Optionally, the first magnetic contact member 1101 and the second magnetic contact member 1201 are both magnetic contact members made of GND iron alloy, and the second magnetic contact member 1201 is further covered with a ring-shaped magnet 1200 (preferably a ring-shaped magnet made of NdFeB), so that the two are closely connected to each other due to the magnetic attraction force when the second magnetic contact member 1201 is close to the first magnetic contact member 1101, and the user only needs to force the connecting portions 150 of the neck strap 12 away from the earphone connectors 110 when it is required to separate the two, which is simple and convenient to operate.

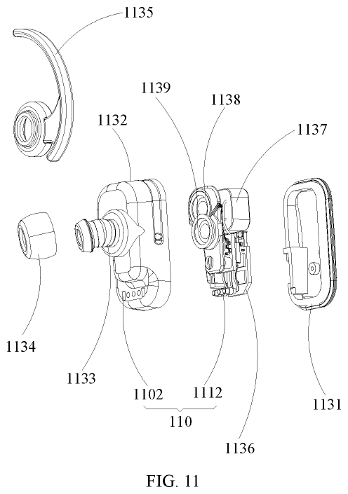

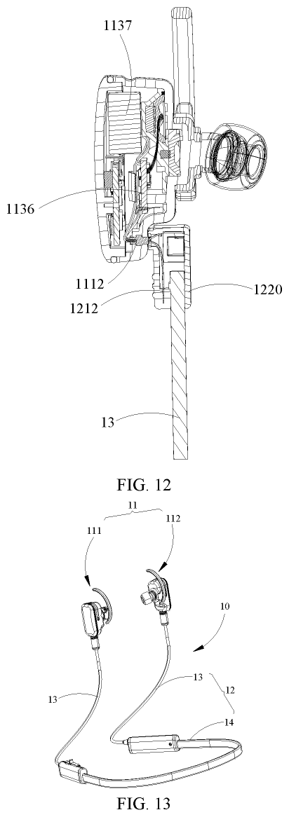

Referring to FIGS. 10-12, in one embodiment, the earphone connectors 110 and the neck strap connectors 150 are connected by a snap fit. Each of the earphone connectors 110 is provided with an engagement hole 1102, and each of the neck strap connectors 150 is correspondingly provided with a buckle 1202. The buckle 1202 may be selected as a push-type buckle. When it is required to connect the earphone connectors 110 with the neck strap connectors 150, the user may press the engagement hole 1102 and place the engagement hole 1102 into the buckle 1202, and then the user releases the engagement hole 1102, at this time the engagement hole 1102 is tightly locked in the buckle 1202, thereby preventing the engagement hole 1102 from falling automatically, thus the connection is firm. When it is required to separate the earphone connectors 110 from the neck strap connectors 150, the user may press the engagement hole 1102 and take it out of the buckle 1202, which is simple and convenient to operate.

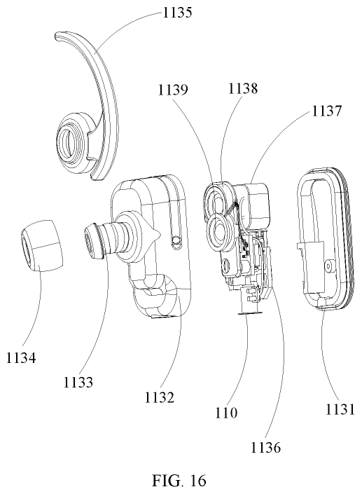

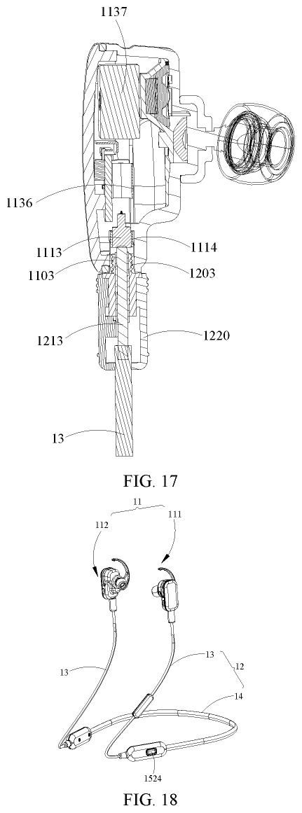

Referring to FIGS. 15-17, in one embodiment, the earphone connectors 110 and the neck strap connectors 150 are connected through a thread. Each of the earphone connectors 110 is provided with an internal thread 1103, and each of the neck strap connectors 150 is provided with an external thread 1203. When the earphone connectors 110 and the neck strap connectors 150 need to be connected, it is only required to screw the external thread 1203 into the internal thread 1103, thus the connection is firm. When the earphone connectors 110 and the neck strap connectors 150 need to be separated, it is only required to screw the external thread 1203 toward an opposite direction to separate it from the internal thread, which is convenient and flexible to operate.

The above connection manner is a physical structural connection between the earphone connectors 110 and the neck strap connectors 150, ensuring that the two can be connected together. When the two are connected, it is also necessary to electrically connect the battery unit 151 to the earphone circuit board 1136. Several electrical connection manners between the earphone connectors 110 and the neck strap connectors 150 are provided below. It should be understood that, the electrical connection form between the earphone connectors 110 and the neck strap connectors 150 may be arranged according to actual needs, which is not limited to the form below.

Referring to FIGS. 4-7, in one embodiment, each of the earphone connectors 110 is provided with an earphone binding post 1111, and the earphone binding post 1111 is connected to the earphone circuit board 1136. Each of the neck strap connectors 150 is provided with a hollow neck strap binding post 1211, and the neck strap binding post 1211 is connected to the battery circuit board 1512 of the battery unit 151. When the earphone connector 110 is connected to the neck strap connector 150, the earphone binding post 1111 is inserted into a through hole of the neck strap binding post 1211, and the electrical connection between the battery unit 151 and the earphone circuit board 1136 is realized by the mating connection between the earphone binding post 1111 and the neck strap binding post 1211. When the earphone connector 110 is separated from the neck strap connector 150, the earphone binding post 1111 is separated from the neck strap binding post 1211.

Referring to FIGS. 10-12, in one embodiment, each of the earphone connectors 110 is provided with an earphone connection terminal 1112 connected to the earphone circuit board 1136, and the earphone connection terminal 1112 may be selected as a copper connection terminal. Each of the neck strap connectors 150 is provided with a flexible metal sheet 1212 connected to the battery unit 151, and the flexible metal sheet 1212 may be selected as a flexible copper sheet. When the earphone connector 110 is connected to the neck strap connector 150, the earphone connection terminal 1112 is in contact with the flexible metal sheet 1212, and the electrical connection between the battery unit 151 and the earphone circuit board 1136 is realized by the mating of the earphone connection terminal 1112 and the flexible metal sheet 1212.When the earphone connector 110 is separated from the neck strap connector 150, the earphone connection terminal 1112 and the flexible metal sheet 1212 are separated from each other. Preferably, the number of the earphone connection terminals 1112 is three, which are respectively VCC (power supply voltage) connection terminal, GND (ground) connection terminal and DATA (data) terminal, and the number of the flexible metal sheets 1212 is correspondingly three, which are correspondingly connected to the above three earphone connection terminals 1112 respectively.

Referring to FIGS. 15-17, in one embodiment, each of the earphone connectors 110 is provided with a first binding post 1113 connected to the earphone circuit board 1136, and the first binding post 1113 is preferably a metal binding post. Each of the neck strap connectors 150 is provided with a second binding post 1213 connected to the battery unit 151, and the second binding post 1213 is preferably a metal binding post. When the earphone connector 110 is connected with the neck strap connector 150, the first binding post 1113 abuts against the second binding post 1213, and the electrical connection between the battery unit 151 and the earphone circuit board 1136 is realized through the mating between the first binding post 1113 and the second binding post 1213. When the earphone connector 110 is separated from the neck strap connector 150, the first binding post 1113 and the second binding post 1213 are separated from each other. In order to ensure that the first binding post 1113 will not be damaged due to collision when the first binding post 1113 abuts against the second binding post 1213, a surface of the first binding post 1113 is sleeved with a damping sponge 1114, which is preferably a damping sponge capable of sensing and buffering insertion, such that a good buffering function is achieved.

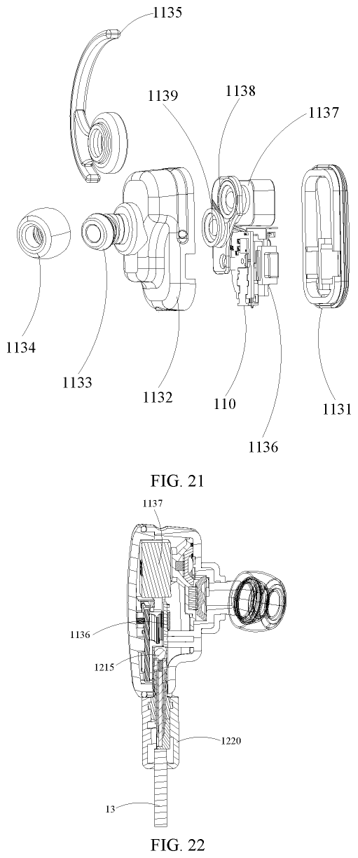

Referring to FIGS. 20-22, in one embodiment, each of the earphone connectors 110 is provided with an earphone jack 1115 connected to the earphone circuit board 1136, and the earphone jack 1115 is preferably a 2.5 mm earphone jack and may charge the battery 1137 of the earphone and transmit a signal for the earphone circuit board 1136. Each of the neck strap connectors 150 is provided with an earphone plug 1215 connected to the battery unit 151. When the earphone connector 110 is connected with the neck strap connector 150, the earphone plug 1215 is plugged into the earphone jack 1115, and the electrical conduction between the battery unit 151 and the earphone circuit board 1136 is realized through the mating connection between the earphone plug 1215 and the earphone jack 1115. When the earphone connector 110 is separated from the neck strap connector 150, the earphone plug 1215 is separated from the earphone jack 1115. Of course, the earphone jack 1115 may also be other types of interfaces, which is not limited to the above case, and the earphone plug 1215 may also be other types of plugs, which is not limited to the above case.

It should be understood that, the above-mentioned physical structure connection manner as well as the electrical connection manner between the earphone connector 110 and the neck strap connector 150 can be combined and designed as needed, thereby obtaining a connecting structure that satisfies different requirements. Several structures including the earphone connector 110 and the neck strap connector 150 are provided below, but are not limited to the following designs.

The first embodiment refers to FIGS. 1-7.

Each of the earphone connectors 110 is provided with an earphone binding post 1111 connected to the earphone circuit board 1136, and a surface of the earphone binding post 1111 is sleeved with a first magnetic contact member 1101. Each of the neck strap connectors 150 is provided with a neck strap binding post 1211 connected to the battery unit 151, the neck strap binding post 1211 is hollow and its surface is sleeved with a second magnetic contact member 1201, and the second magnetic contact member 1201 is further covered with a ring-shaped magnet 1200. In order to better protect the above components, each of the neck strap connectors 150 is further provided with a housing 1220, the ring-shaped magnet 1200 is accommodated in the housing 1200, one end of the second magnetic contact member 1201 and one end of the neck strap binding post 1211 are accommodated in the housing 1200, and the other ends extend out of the housing 1220 to facilitate connection with the earphone connector 110. When the earphone connector 110 is connected with the neck strap connector 150, the first magnetic contact member 1101 and the second magnetic contact member 1201 are connected through magnetic adsorption, and the earphone binding post 1111 is inserted into the neck strap binding post 1211 to realize the electrical conduction between the battery unit 151 and the earphone circuit board 1136. When the earphone connector 110 is separated from the neck strap connector 150, the user is only required to force the connector 150 of the neck strap 12 away from the earphone connector 110, and at the same time the earphone binding post 1111 and the neck strap binding post 1211 are separated.

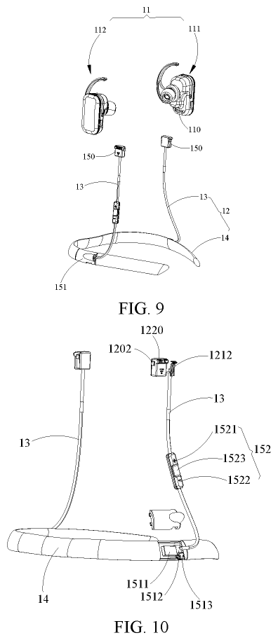

The second embodiment refers to FIGS. 8-12.

Each of the neck strap connectors 150 is provided with a housing 1220, the interior of the housing 1220 is provided with a flexible metal sheet 1212 connected to the battery unit 151, and opposite two sides of the housing 1220 are provided with a press-type engagement hole 1102. Each of the earphone connectors 110 is provided with an earphone connection terminal 1112 connected with the earphone circuit board 1136, and a position of the earphone connector 110 corresponding to the is connected is provided with a card hole 1102 at a position corresponding to press-type engagement hole 1102 is provided with a buckle 1202. When the earphone connector 110 is connected with the neck strap connector 150, the user may press the engagement hole 1102 and insert the engagement hole 1102 into the buckle 1202, and then the user releases the engagement hole 1102, at this time the engagement hole 1102 will be locked in the buckle 1202, and the earphone connection terminal 1112 is in contact with the flexible metal sheet 1212 to realize electrical conduction between the battery unit 151 and the earphone circuit board 1136 through the mating between the earphone connection terminal 1112 and the flexible metal sheet 1212. When the earphone connection component 110 is separated from the neck strap connector 150, the user presses the engagement hole 1102 and takes it out of the buckle 1202, while the earphone connection terminal 1112 and the flexible metal sheet 1212 are separated from each other.

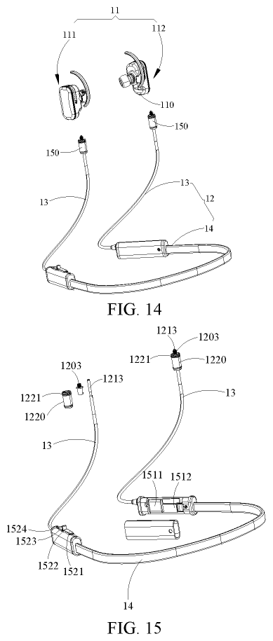

The third embodiment refers to FIGS. 13-17.

Each of the earphone connectors 110 is provided with a first binding post 1113 connected to the earphone circuit board 1136, and a surface of the first binding post 1113 is sleeved with a damping sponge 1114, in this case each of the earphone connectors 110 is further provided with an earphone connecting member fixed in a front housing 1132, and the interior of the connecting member is provided with an internal thread 1103. Each of the neck strap connectors 150 is provided with a second binding post 1213 connected to the battery unit 151, the second binding post 1213 is sleeved with a neck strap connecting member, an outer surface of the connecting member is provided with an external thread 1203, and one end of the second binding post 1213 and one end of the external thread 1203 are accommodated in the housing 1220, and the other ends extend outside the housing 1220. In order to ensure that it is more convenient for the user to operate, the surface of the housing 1220 is further provided with a strip-like texture 1221, which can increase friction when the user connects the neck strap connector 150 with the earphone connector 110. When the earphone connector 110 is connected with the neck strap connector 150, it is only required to screw the external thread 1203 into the internal thread 1103, in this case the first binding post 1113 abuts against the second binding post 1213, and the electrical conduction between the battery unit 151 and the earphone circuit board 1136 is realized through mating between the first binding post 1113 and the second binding post 1213. When the earphone connector 110 is separated from the neck strap connector 150, it is only required to screw the external thread 1203 toward an opposite direction to separate it from the internal thread, at this time the first binding post 1113 and the second binding post 1213 are separated from each other.

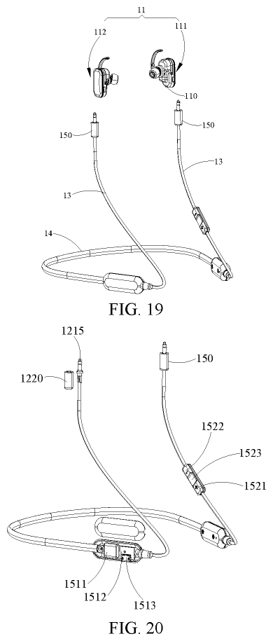

The fourth embodiment refers to FIGS. 18-22.

Each of the earphone connectors 110 is provided with an earphone jack 1115 connected to the earphone circuit board 1136, and each of the neck strap connectors 150 is provided with an earphone plug 1215 connected to the battery unit 151. One end of the earphone plug 1215 is accommodated in the housing 1220, and the other end extends outside the housing 1220. When the earphone connector 110 is connected with the neck strap connector 150, the earphone plug 1215 is plugged into the earphone jack 1115, and the electrical conduction between the battery unit 151 and the earphone circuit board 1136 is realized through mating connection between the earphone plug 1215 and the earphone jack 1115, and at the same time the earphone connector110 is firmly connected to the neck strap connector 150. When the earphone connector 110 is separated from the neck strap connector 150, the earphone plug 1215 is separated from the earphone jack 1115.

The above description only describes the embodiments of the present application, and is not intended to limit the present application. Any modification, equivalent, and improvement made within the spirit and principle of the present application should be included in the protection scope of the present application.

What is claimed is:

1. A neck-strap type earphone, comprising a wireless earphone assembly and a neck strap,
wherein the neck strap is provided with two neck strap connectors and a battery unit, and the two neck strap connectors are arranged on the neck strap and connected with the battery unit;
wherein the wireless earphone assembly comprises a left earphone and a right earphone that are capable of being worn and used separately;
wherein the left earphone and the right earphone are each provided with an earphone connector, and the earphone connectors are detachably connected with the neck strap connectors;
wherein the left earphone and the right earphone are configured for wearing and use upon connection with the neck strap.

2. The neck-strap type earphone according to claim 1, wherein the neck strap comprises two connecting wires and a collar;
the two connecting wires are connected with the collar, and each of free ends of the two connecting wires is connected with one neck strap connector;
the battery unit is arranged in the collar.

3. The neck-strap type earphone according to claim 1, wherein the battery unit comprises a battery and a battery circuit board, the battery is connected with the battery circuit board, and the battery circuit board is connected with the neck strap connectors.

4. The neck-strap type earphone according to claim 3, wherein the battery is a rechargeable battery, and the battery circuit board is provided with a charging connection portion.

5. The neck-strap type earphone according to claim 3, wherein the battery is a replaceable battery, the battery unit further comprises a battery box, and the battery is arranged in the battery box.

6. The neck-strap type earphone according to claim 1, wherein the neck strap is further provided with a control unit at least configured to control the wireless earphone assembly, and the control unit is connected with the battery unit, and the control unit is connected with the neck strap connectors.

7. The neck-strap type earphone according to claim 6, wherein the control unit is provided with at least one of a volume control button, a mode button and a control button;
wherein the mode button is configured to control a working mode of the wireless earphone assembly;
wherein the control button is configured to control a play state of the wireless earphone assembly.

8. The neck-strap type earphone according to claim 6, wherein the neck strap is further provided with a voice pickup, and the voice pickup is connected with the control unit.

9. The neck-strap type earphone according to claim 1, wherein each of the earphone connectors is provided with a first magnetic contact member, each of the neck strap connectors is provided with a second magnetic contact member, and the first magnetic contact member is matingly connected with the second magnetic contact member.

10. The neck-strap type earphone according to claim 1, wherein each of the earphone connectors is provided with a buckle, each of the neck strap connectors is provided with an engagement hole, and the buckle is matingly connected with the engagement hole.

11. The neck-strap type earphone according to claim 1, wherein each of the earphone connectors is provided with an internal thread, each of the neck strap connectors is provided with an external thread, and the internal thread is matingly connected with the external thread.

12. The neck-strap type earphone according to claim 1, wherein the left earphone and the right earphone are provided with an earphone circuit board and an earphone battery, the earphone circuit board is provided with a wireless communication module, and the earphone battery and the earphone connectors are connected with the earphone circuit board.

13. The neck-strap type earphone according to claim 12, wherein the earphone circuit board is further provided with a clicking sensor configured to sense clicking from a user and control the wireless earphone assembly; and/or
the earphone circuit board is further provided with an earphone control button configured to control a working mode of the wireless earphone assembly.

14. The neck-strap type earphone according to claim 12, wherein each of the earphone connectors is provided with an earphone jack connected to the earphone circuit board, each of the neck strap connectors is provided with an earphone plug connected to the battery unit, and the earphone plug is matingly connected with the earphone jack in an insertion manner.

15. The neck-strap type earphone according to claim 12, wherein each of the earphone connectors is provided with an earphone binding post connected to the earphone circuit board, each of the neck strap connectors is provided with a neck strap binding post connected to the battery unit, and the earphone binding post is matingly connected with the neck strap binding post.

16. The neck-strap type earphone according to claim 12, wherein each of the earphone connectors is provided with an earphone connection terminal connected with the earphone circuit board, each of the neck strap connectors is provided with a flexible metal sheet connected with the battery unit, and the flexible metal sheet is matingly connected with the earphone connection terminal.

17. The neck-strap type earphone according to claim 12, wherein each of the earphone connectors is provided with a first binding post connected with the earphone circuit board, each of the neck strap connectors is provided with a second binding post connected with the battery unit, and the first binding post abuts against the second binding post.

18. The neck-strap type earphone according to claim 17, wherein a surface of the first binding post is sleeved with a damping sponge configured to play a role of buffering when the first binding post abuts against the second binding post.
